(19) United States
(12) Patent Application Publication
(10) Pub. No.: US 2023/0153261 A1
(43) Pub. Date: May 18, 2023

(54) PROCESSOR AND ARITHMETIC PROCESSING METHOD

(71) Applicants: Fujitsu Limited, Kawasaki-shi (JP); Inter-University Research Institute Corporation Research Organization of Information and Systems, Tokyo (JP)

(72) Inventors: Toshiyuki Ichiba, Kawasaki (JP); Masahiro Goshima, Chiyoda (JP)

(73) Assignees: Fujitsu Limited, Kawasaki-shi (JP); Inter-University Research Institute Corporation Research Organization of Information and Systems, Tokyo (JP)

(21) Appl. No.: 17/893,389

(22) Filed: Aug. 23, 2022

(30) Foreign Application Priority Data
Nov. 15, 2021 (JP) 2021-185401

(51) Int. Cl. G06F 13/40; G06F 13/16

(52) U.S. Cl. CPC G06F 13/4068; G06F 13/1684

(57) ABSTRACT

A processor includes issuing units to issue a read access request to a storage, a cache including banks capable of holding first data divided from data read from the storage, a switch interconnecting the issuing units and the banks, and a data distribution unit disposed between the issuing units and the switch. The switch outputs one of read access requests to a bank that is a read target, when each of read target data of the read access requests issued from the issuing units is one of second data included in the first data, and the first data read from the bank is output to the data distribution unit. The data distribution unit outputs each of the second data, divided from the first data received from the switch, in parallel to an issuing unit that is an originator of the read access request.

### CROSS-REFERENCE TO RELATED APPLICATIONS

This application is based upon and claims the benefit of priority of the prior Japanese Patent Application No. 2021-15401, filed on Nov. 15, 2021, the entire contents of which are incorporated herein by reference.

### FIELD

Embodiments discussed herein relate, to processors and processing methods. The processor may sometimes also be referred to as an arithmetic processing unit, a processing unit, or the like. The arithmetic processing method may sometimes also be simply referred to as a processing method.

### BACKGROUND

A cache mounted in a processor, such as a central processing unit (CPU) or the like, holds a portion of data stored in an external memory. When the cache holds target data of a read access request issued from the CPU and a cache hit occurs, the cache transfers the data held in the cache to a CPU core or the like without issuing the read access request to the external memory. As a result, a data access efficiency is improved, and a processing performance of the CPU is improved.

For example, a memory controller, that is provided in a semiconductor device together with the CPU and controls the external memory, includes bank caches respectively corresponding to each of a plurality of banks provided in the external memory, as proposed in Japanese Laid-Open Patent Publication No. 2005-339348, for example. A level 2 cache provided in the processor includes a plurality of independently accessible storage blocks, as proposed in Japanese Laid-Open Patent Publication No. 2006-5072, for example. A memory including a plurality of normal banks and a plurality of cache banks moves data output from a selected normal bank to a cache bank when consecutive accesses are made with respect to the normal banks, as proposed in Japanese Laid-Open Patent Publication No. 2004-55112, for example.

Recently, a processor capable of executing a Single Instruction Multiple Data (SIMD) arithmetic instruction has been proposed to perform vector operations or the like in parallel. This type of processor can execute SIMD arithmetic instructions having various data sizes. For example, when using a plurality of data having consecutive addresses and a data size that is one-half a data width of the cache bank for the SIMD operation, a conflict of a plurality of read access requests with respect to a single bank may occur. In this case, the read access requests are successively supplied to the bank, and access target data are successively read from the bank. Because the SIMD operation is performed after all of the access target data are read, an execution timing of the SIMD operation is delayed, to thereby deteriorate a computing efficiency.

### SUMMARY

According to one aspect, it is one object of the present disclosure to reduce a delay of reading a plurality of second data, even when read target data of a plurality of read access requests respectively are the plurality of second data included in first data held in a bank.

According to one aspect of the embodiments, a processor includes a of request issuing units respectively configured to issue a read access request with respect to a storage; a cache including a plurality of banks respectively capable of holding first data divided. from data read from the storage; a switch configured to interconnect the plurality of request issuing units and the plurality of banks; and a data distribution unit disposed between the plurality of request issuing units and the switch, wherein the switch outputs one read access request of a plurality of read access requests to a bank that is a read target, when each of read target data of the plurality of read access requests issued from the plurality of request issuing units is one second data or a plurality of second data included in the first data, the first data including the plurality of second data read from the bank is output to the data distribution unit, and the data distribution unit outputs each second data of the plurality of second data, divided from the first data received from the switch, in parallel to a request issuing unit that is an originator of the read access request.

The object and advantages of the invention will be realized and attained by means of the elements and combinations particularly pointed out in the claims.

It is t be understood o that both the foregoing general description and the following detailed description are exemplary and explanatory and are not restrictive or the invention, as claimed.

### BRIEF DESCRIPTION OF DRAWINGS

FIG. 1 is a block diagram illustrating an example of a processor according to a first embodiment;

FIG. 2 is a diagram for explaining an example of a memory access operation of the processor illustrated in FIG. 1;

FIG. 3 is a block diagram illustrating an example of the processor according to a second embodiment;

FIG. 4 is a block diagram illustrating an example of a data distribution unit illustrated in FIG. 1;

FIG. 5 is a diagram for explaining an example of data disposed in a cache illustrated in FIG. 3 or a cache illustrated in FIG. 1;

FIG. 6 is a diagram for explaining an example of an operation of a data distribution unit illustrated in FIG. 3 or the data distribution unit illustrated in FIG. 1 during a normal load;

FIG. 7 is a diagram for explaining an example of the operation of the data distribution unit illustrated in FIG. 3 or the data distribution unit illustrated in FIG. 1 during a sign-extending load;

FIG. 8 is a diagram for explaining another example of the operation of the data distribution unit illustrated in FIG. 3 or the data distribution unit illustrated in FIG. 1 during the sign-extending load;

FIG. 9 is a diagram for explaining an example of a sparse matrix vector multiplication;

FIG. 10 is a diagram for explaining an example of an operation when computing the sparse matrix vector multiplication; and

FIG. 11 is a diagram for explaining another example of the operation when computing the sparse matrix vector multiplication.

### DESCRIPTION OF EMBODIMENTS

Preferred embodiments of the present disclosure will be described with reference to the accompanying drawings.

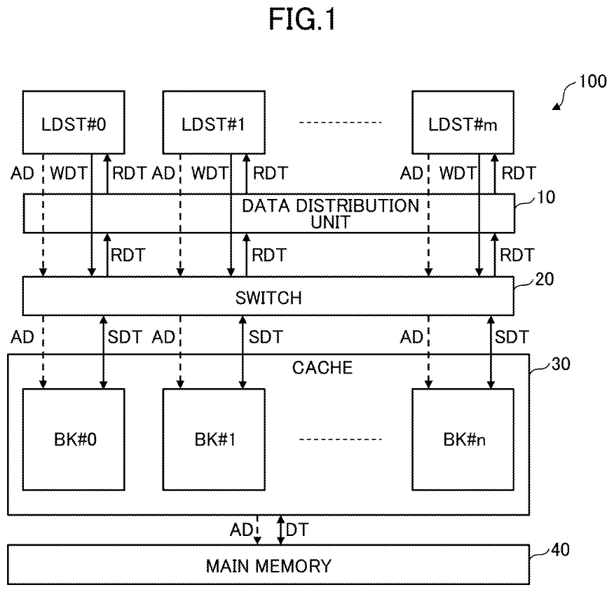

FIG. 1 illustrates an example of a processor according to a first embodiment. A processor 100 illustrated in FIG. 1 may be a Central Processing Unit (CPU) or the like having a function to execute multiply-add operations or the like in parallel, using the Single Instruction Multiple Data (SIMD) arithmetic instruction, for example. For example, the processor 100 is capable of executing a Sparse Matrix Vector multiplication (SpMV) used for numerical processing, graph processing, or the like.

The processor 100 includes m+1 load store units LDST (LDST #0 through LDST #m), where m is an integer greater than or equal to 1, a data distribution unit 10, a switch 20, and a cache 30. The load store unit LDST is an example of a request issuing unit that issues a memory access request to a main memory 40. The memory access request includes a write access request to write data to the main memory 40, and a read access request to read data from the main memory 40. The main memory 40 is an example of a storage.

The cache 30 operates as a Level 1 (L1) data cache capable of holding a portion of the data stored in the main memory 40 that is connected to the processor 100. The cache 30 includes n+1 banks BK (BK #0 through BK #n), where n is an integer greater than or equal to 1. By dividing the cache 30 into the plurality of banks BK, it is possible to improve the so-called gather/scatter performance. The processor 100 may include a cache controller (not illustrated) that controls the operation of the cache 30. The cache controller may be included in the cache 30, for example.

The processor 100 may include an instruction fetch unit, an instruction decoder, a reservation station, an arithmetic unit including various computing elements, a register file, or the like that are not illustrated. FIG. 1 illustrates blocks, or constituent elements, that are mainly related to a memory access. For example, the instruction fetch unit, the instruction decoder, the reservation station, the arithmetic unit including the various computing elements and the register file are included in a CPU core that is not illustrated.

When a load instruction is received, the load store unit LDST outputs a read access request to the bank BK that is a read target, via the switch 20, and receives the data read from the bank BK via the switch 20 and the data distribution unit 10. For example, the read access request, that is issued from the load store unit LDST in correspondence with the load instruction, includes read control information indicating an address AD of the read target and the read access request.

When a store instruction is received, the load store unit LDST outputs a write access request to the bank BK indicated by the address AD, via the switch 20. For example, the write access request, that is issued from the load store unit LDST in correspondence with the store instruction, includes write control information indicating the address AD of a write target, a write data WDT, and a write request.

The m+1 load store units LDST may receive mutually independent load instructions or store instructions, and output mutually independent memory access requests. In this embodiment and embodiments that will be described later, an example in which the load store unit LDST that receives a load instruction issues a read access request will be described. For example, methods of loading the data by the load instruction include a normal load and a sign-extending load. The normal load is performed in response to a non-sign-extending type read access request. The sign-extending load is performed in response to a sign-extending type read access request.

During the normal load, a sub data SDT, corresponding to data amounting to a data width of the bank BK, is output to the load store unit LDST that is an originator or issue source of the read access request. That is, in the case of the non-sign-extending type read access request, the data read from the bank BK is directly output as is to the load store unit LDST.

During the sign-extending load, divided data (or segmented data) obtained by dividing (or segmenting) the sub data SDT is output to the load store unit LDST that is the originator of the read access request, as data of lower bits of the sub data SDT. The sign-extending load may involve a sign extension. In this case, “0”is embedded in data of upper bits of the sub data SDT when the data of the lower bits of the sub data SDT is a positive value, and “1”is embedded in the data of the upper bits of the sub data SDT when the data of the lower bits of the sub data SDT is a negative value. In the following description, it is assumed that in the sign-extending load, data amounting to one-half of the data width of the bank BK is output to the load store unit LDST as lower bit data. The sub data SDT is an example of a first data.

Each bank BK holds the sub data SDT obtained by dividing the data DT read from the main memory 40 when a cache miss of the memory access request occurs. The sub data SDT has a size obtained by dividing the cache line size, that is the unit of reading and writing the data DT with respect to the main memory 40, by the number of the banks BK, and the size of the sub data SDT matches the data width of the bank BK. Each bank BK outputs the sub data SDT that is a read target to the switch 20 when a cache hit of the memory access request occurs.

The switch 20 includes a plurality of ports respectively connected to the plurality of load store units LDST, a plurality of ports respectively connected to a plurality of ports of the data distribution unit 10, and a plurality of ports respectively connected to the plurality of banks BK. For example, the switch 20 interconnects the plurality of load store units LDST and the plurality of banks BK. The switch 20 outputs the read access request to the bank BK indicated by a bank address included in the read access request. The bank BK indicated by the bank address included in the read access request is an example of a read target bank BK that is a target of the read. The switch 20 receives the read data DT from the bank BK that output the read access request, and outputs the read data DT to the data distribution unit 10, as a read data RDT.

The data distribution unit 10 includes a plurality of ports respectively connected to the plurality of load store, units LDST, and a plurality of ports respectively connected to a plurality of ports of the switch 20. The data distribution unit 10 outputs the read data RDT received from the switch 20 to the load store unit LDST that is the originator of the memory access request.

For example, when the bank addresses included in the read access requests output from a plurality of load store units LDST indicate a single bank BK, a conflict (or collision) of the read access requests occurs. That is, the conflict of the read access requests occurs at the read target banks BK. When the conflict of the read access requests occurs during the normal load, the switch 20 successively outputs the read access requests to the bank BK, and successively reads the sub data SDT from the bank BK. The switch 20 successively outputs the sub data SDT to the data distribution unit 10, as the read data RDT. The data distribution unit 10 successively outputs the read data RDT received from the switch 20 to the load store unit LDST that is the originator of the read access request.

On the other hand, when two read access requests indicate a single bank BK (conflict occurs) during the sign-extending load, the switch 20 performs different operations according to whether or not the addresses of the read targets (that is, read target addresses) indicate a common sub data SDT. When the sub data SDT indicated by the read target addresses differ, the switch 20 successively outputs the read access requests to the bank BK, similarly to the case where conflict of the read access requests occurs during the normal load.

The switch 20 successively reads out the sub data SDT including the divided data that is the read target from the bank BK. The switch 20 successively outputs the sub data SDT to the data distribution unit 10, as the, read data RDT. The data distribution unit 10 successively outputs the divided data of the read target of the read data RDT received from the switch 20 to the load store unit LDST that is the originator of the read access request. The divided data is an example of a second data.

On the other hand, when the read target addresses indicate the same sub data SDT during the sign-extending load, the addresses indicating the sub data SDT are the same in the two read access requests, and only offset addresses indicating the divided data differ. For this reason, the switch 20 outputs one of the read access requests to the bank BK, and reads the sub data SDT including the two divided data of the read targets from the bank BK. The switch 20 outputs the read sub data SDT (including the two divided data) to the data distribution unit 10, as the read data RDT.

The data distribution unit 10 sets the two divided data included in the read data RDT received from the switch 20 to the lower bits, respectively. Further, the data distribution unit 10 simultaneously outputs the read data RDT in which the two divided data are respectively set to the lower bits, to the load store unit LDST that is the originator of the read access request. The read data RDT that are output simultaneously do not need to be output at a strictly simultaneous timing, as long as the read data RDT are output in parallel.

The switch 20 and the data distribution unit 10 may operate based on control by a controller, such as an arbitration unit or the like (not illustrated). In this case, the controller may identify the read target bank BK according to the address included in the memory access request issued from the load store unit LDST, and determine whether or not a conflict of the memory access requests occurred. The controller may control the operations of the switch 20 and the data distribution unit 10 according to a determination result.

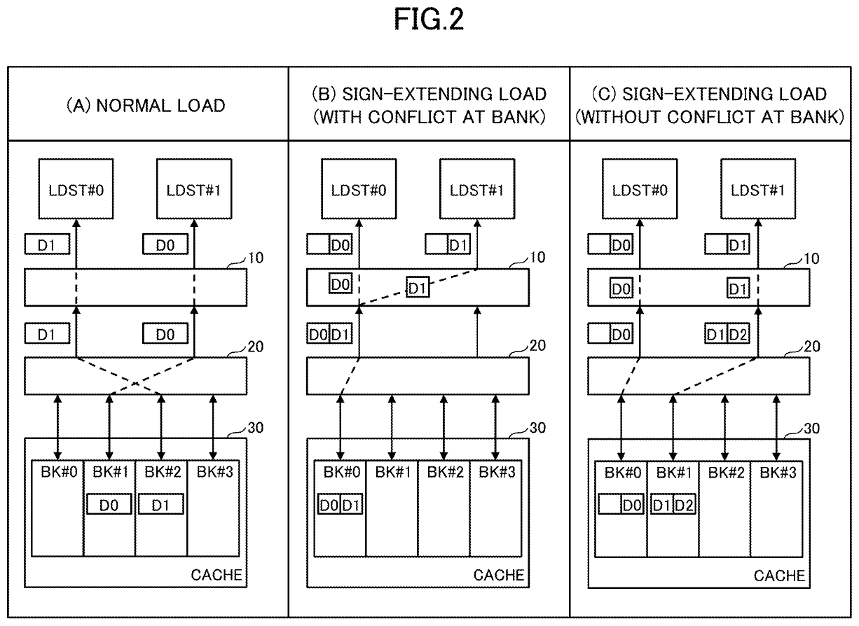

FIG. 2 illustrates an example of the memory access operation of the processor illustrated in FIG. 1. That is, FIG. 2 illustrates an example of an arithmetic processing method performed by the processor 100. In order to simplify the description, it is assumed for the sake of convenience that the processor 100 illustrated in FIG. 2 includes two load store units LDS #0 and LDST #1, and four banks BK #0 through BK #3. Further, in FIG. 2, it is assumed that only the data transferred from the bank BK to the load store unit LDST based on the read access request is illustrated. In the following description, it is assumed that a cache hit of the read access request occurs.

In a section (A) illustrated in FIG. 2, the load store units LDST #0 and LDST #1 during the normal load simultaneously issue the read access requests with respect to the banks BK #2 and BK #1. Because a conflict of the read access requests does not occur, the switch 20 simultaneously issues the read access requests with respect to the banks BK #1 and BK #2. The banks BK #1 and BK #2 respectively output target data D0 and D1 (sub data SDT) of the read access requests to the switch 20.

The switch 20 outputs the, data D0 and D1 transferred from the banks BK #1 and BK #2 to the data distribution unit 10. In this state, the switch 20 outputs the data D0 and D1 to the ports of the data distribution unit 10 capable of outputting the data D0 and D1 to the originators of the read access requests. The data distribution unit 10 outputs the data D0 and D1 received from the switch 20 to the ports connected to the load store units LDST #1 and LDST #0 that are the originators of the read access requests.

In a section (B) illustrated in FIG. 2, the load store units LDST #0 and LDST #1 during the sign-extending load simultaneously issue the read access requests with respect to the bank BK #0. In this case, the target addresses of the two read access requests indicate a storage location of the same sub data SDT, and only the addresses of storage locations of the divided data D0 and D1 included in the sub data SDT differ.

When a conflict of the addresses of the sub data SDT included in the read access requests occurs, the switch 20 outputs one of the read access requests to the bank BK #0. The bank BK #0 outputs the target sub data SDT (divided data D0 and D1) of the read access request to the switch 20. The switch 20 outputs the divided data D0 and D1 transferred from the bank BK #0 to the data distribution unit 10.

The data distribution unit 10 outputs the divided data D0 and D1 respectively received from the switch 20 in parallel (for example, simultaneously) to the ports connected to the load store units LDST #0 and LDST #1 that are the originators of the read access requests. In this state, the divided data D0 and D1 are respectively output to the load store units LDST #0 and LDST #1, as the lower bit data.

As described above, the switch 20 outputs only one of the read access requests to the read target bank BK #0 when the divided data D0 and D1 that are read targets of the two read access requests are included in the sub data SDT. In addition, the switch 20 reads the two divided data D0 and D1 simultaneously from the bank BK, and outputs the two divided data D0 and D1 to the data distribution unit 10, as the sub data SDT. The data distribution unit 10 divides the sub data SDT into the two divided data D0 and D1, and outputs the divided data D0 and D1 in parallel to the respective load store units LDST that are the originators of the read access requests.

Accordingly, during the sign-extending load, even when the divided data D0 and D1 that are the read targets are included in the same sub data SDT, the divided data D0 and D1 can be read simultaneously and output in parallel to the load store units LDST #0 and LDST #1. In other words, even when the read target data of the plurality of read access requests are the plurality of divided data included in the sub data SDT held in the bank BK, it is possible to reduce a delay in the reading of the plurality of divided data.

In a section (C) illustrated in FIG. 2, the load store units LDST #0 and LDST #1 during the sign-extending load simultaneously issue, the read access requests with respect to the banks BK #0 and BK #1. That is, a conflict of the two read access requests does not occur. The switch 20 outputs the two read access requests to the banks BK #0 and BK #1, respectively.

The bank BK #0 outputs the sub data SDT including the divided data D0, that is the target of the read access request, to the switch 20. The bank BK #1 outputs the sub data SDT including the divided data D1, that is the target of the read access request, to the switch 20. The switch 20 outputs the sub data SDT including the divided data D0 (or D1) respectively transferred from the banks BK #0 and BK #1, to the data distribution unit 10.

The data distribution unit 10 outputs the divided data D0 and D1 respectively received from the switch 20 in parallel (for example, simultaneously) to the ports connected to the load store units LDST #0 and LDST #1 that are the originators of the read access requests. In this state, the divided data D0 and D1 are respectively output to the load store units LDST #0 and LDST #1, as the lower bit data.

As described above, in this embodiment, even when the divided data D0 and D1 that are the read targets are included in the same sub data SDT in the sign-extending load, the divided data D0 and D1 can be read simultaneously read and output in parallel to the load store units LDST #0 and LDST #1. In other words, even when the read target data of the plurality of read access requests respectively are the plurality of divided data included in the sub data SDT held in the bank BK, it is possible to reduce a delay in the reading of the plurality of divided data.

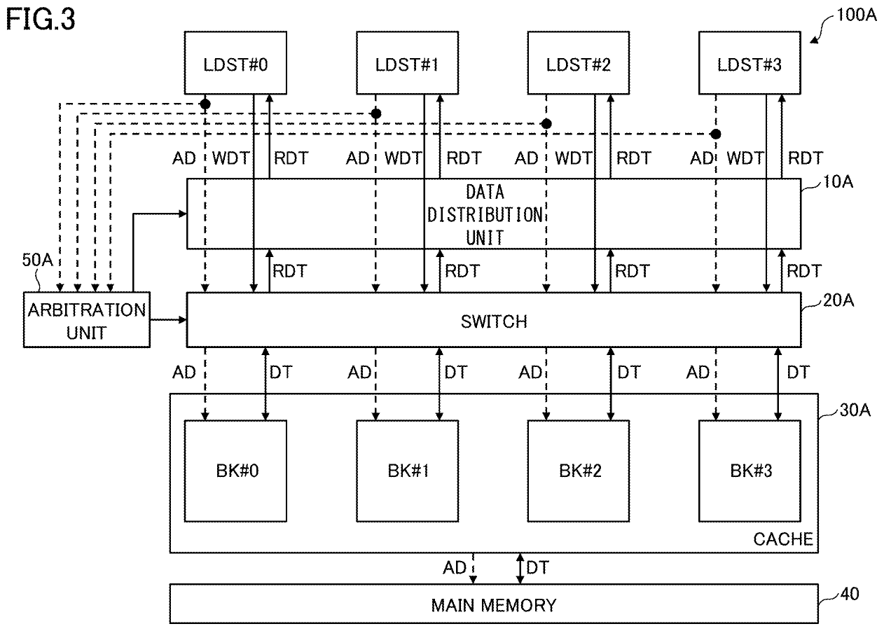

FIG. 3 illustrates an example of a processor according to a second embodiment. In this embodiment, constituent elements that are the same as the constituent elements of the first embodiment described above are designated by the same reference numerals, a detailed description thereof will be omitted. A processor 100A illustrated in FIG. 3 may be a CPU or the like having a function to execute multiply-add operations or the like in parallel, using the SIMD arithmetic instruction, for example. For example, the processor 100A is capable of executing the SpMV.

The processor 100A includes four load store units LDST (LDST #0 through LDST #3), a data distribution unit 10A, a switch 20A, a cache 30A including four banks BK #0 through BK #3, and an arbitration unit 50A. The cache 30A operates as a L1 (Level 1) data cache. The processor 100A may include a cache controller that controls the operation of the cache 30A. In addition, the processor 100A may include an instruction fetch unit, an instruction decoder, a reservation station, an arithmetic unit including various computing elements, a register file, or the like that are not illustrated.

The data distribution unit 10A operates in a manner similar to the data distribution unit 10 illustrated in FIG. 1, and the switch 20A operates in a manner similar to the switch 20 illustrated in FIG. 1. The arbitration unit 50A determines whether or not a conflict of the read access requests occurred, based on the address AD included in the read access requests out from the load store units LDST, and controls the operations of the switch 20A and the data distribution unit 10A according to a determination result. That is, the arbitration unit 50A arbitrates the read access requests issued from the plurality of load store units LDST, and controls the operations of the switch 20A and the data distribution unit 10A according to an arbitration result.

By controlling the operation of the data distribution unit 10A by the arbitration unit 50A, the plurality of divided data read from the banks BK can be output in parallel to the load store units LDST, even when the conflict of the read access requests occurs during the sign-extending load.

Moreover, the arbitration unit 50A determines whether or not a conflict of the write access requests output from the load store units LDST occurred, based on the address AD included in the write access requests, and controls the operation of the switch 20A according to a determination result.

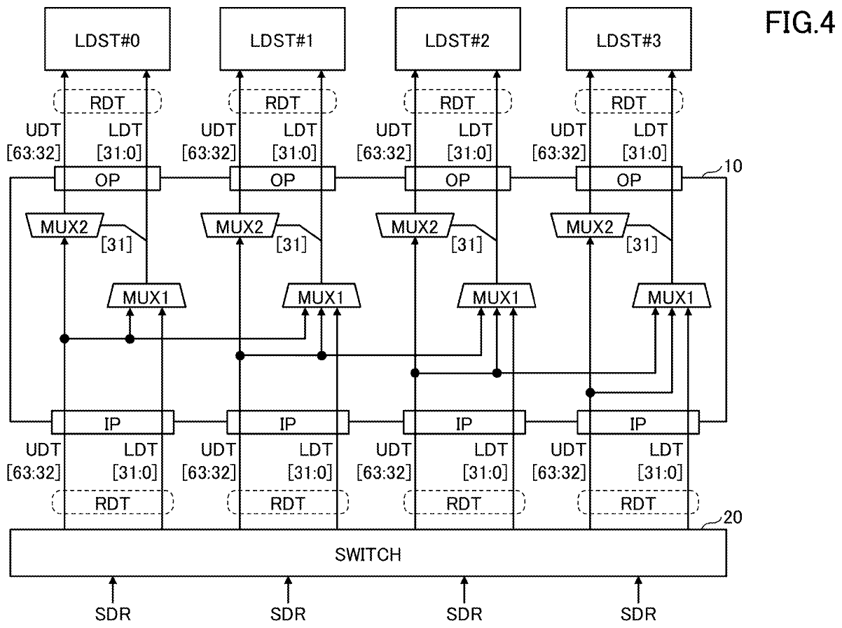

FIG. 4 illustrates an example of the data distribution unit 10 illustrated in FIG. 1. FIG. 4 may be an example of the data distribution unit 10A illustrated in FIG. 3.

The data distribution unit 10 includes four data input ports IP that respectively receive four read data RDT from the switch 20. The data distribution unit 10 also includes four data output ports OP respectively connected to the load store units LDST #0 through LDST #3.

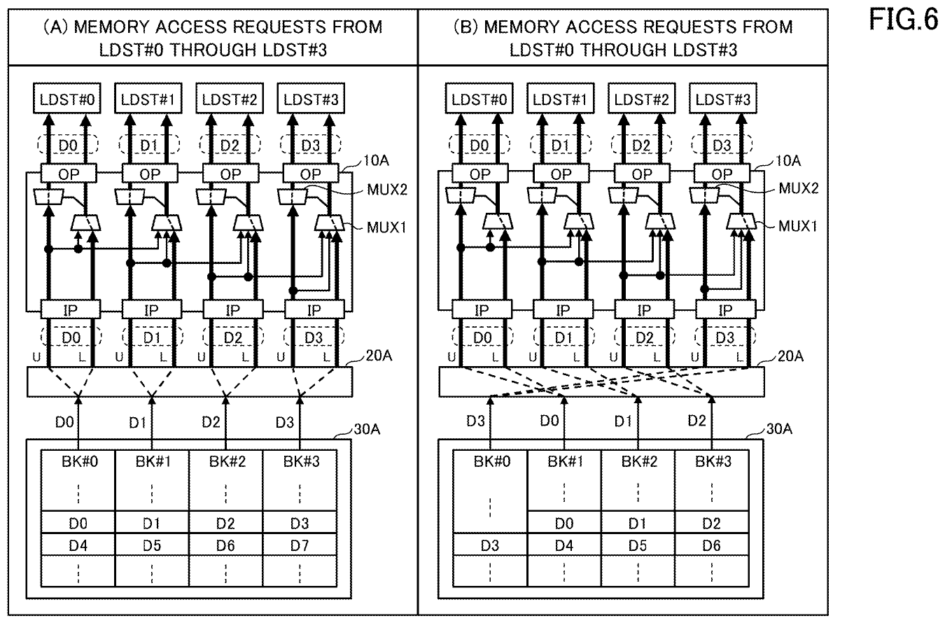

The four data output ports OP are provided in correspondence with the four data input ports IP. The number of the data input ports IP and the number of the data output ports OP of the data distribution unit 10 are the same as the number of the load store units LDST. For this reason, by transferring the sub data SDT read from the bank BK to one of the data input ports IP by the switch 20, the sub data SDT or the divided data can be output to the load store unit LDST that is the originator of the read access request. An example in which the data distribution unit 10 transfers the sub data SDT or the divided data read from the bank BK to the load store unit LDST will be described later in conjunction with FIG. 6 through FIG. 8.

In addition, the data distribution unit 10 includes multiplexers MUX1 and MUX2 for each pair of the data input port IP and the data output port OP. The multiplexer MUX1 is an example of a lower bit selector. The multiplexer MUX2 is an example of an upper bit selector. The multiplexers MUX1 and MUX2 are an example of a selector.

The switch 20 is controlled by the arbitration unit (the arbitration unit 50A illustrated in FIG. 3, for example) that is not illustrated in FIG. 4. This arbitration unit arbitrates the read access requests issued from the plurality of load store units LDST, and controls the operations of the switch 20 and the data distribution unit 10 according to the arbitration result. The switch 20 outputs the read data RDT read from the banks BK to the data input ports IP corresponding to the data output ports OP connected to the load store units LDST that are the originators of the read access requests.

In the following description, it is assumed that the read data RDT read from the banks BK have 64 bits. It is also assumed that the read data RDT includes upper data UDT [63:32] of the upper 32 bits, and lower data LDT [31:0] of the lower 32 bits. The read data RDT and the sub data SDT output from the banks BK are examples of the first data. The data UDT and LDT obtained by dividing the read data RDT into two data portions, and the divided data included in the sub data SDT, are example of the second data.

Each multiplexer MUX1 selects one of the data LDT or the data UDT received by the data input port IP. Each multiplexer MUX1 outputs the selected data from the data output port OP, as the lower bit data LDT, to the load store unit LDST via a lower bit data line. When the read access request indicates the normal load, each multiplexer MUX1 always selects the data LDT received by the data input port IP.

Each multiplexer MUX2 selects one of the data UDT received at the data input port IP, an all-“0” data, and an all-“1”data. Each multiplexer MUX2 outputs the selected data from the data output port OP, as the upper bit data UDT, to the load store unit LDST via a upper bit data line.

When the read access request indicates the normal load, the multiplexer MUX2 outputs the data UDT received by the data input port IP to the upper bit data output port OP. Accordingly, during the normal load, the data distribution unit 10 can output the lower bit data and upper bit data received by the data input port IP, as the lower data and upper data of the load store unit LDST, via the multiplexers MUX1 and MUX2. In other words, the data distribution unit 10 during the normal load can output the sub data SDT read from the bank BK, as is, to the load store unit LDST that is the originator of the read access request.

The multiplexer MUX2 outputs the all-“0”data UDT to the upper bit data output port OP, when the read access request indicates the sign-extending load and the divided data (UDT or LDT) received by the data input port IP air positive value.

The multiplexer MUX2 outputs the all-“1” data UDT to the upper bit data output port OP, when the read access request indicates the sign-extending load and the divided data (UDT or LDT) received by the data input port IP is a negative value. The multiplexer MUX2 determines that the divided data is a positive value when a most significant bit [31] (sign bit) output from the multiplexer MUX1 is “0”, and determines that the divided data is a negative value when the most significant bit [31] (sign bit) output from the multiplexer MUX1 is “1”.

Accordingly, the sign-extending load may involve a sign extension that reads the data with the sign bit extended to the upper bits. The data distribution unit 10 can generate a 64-bit data having the negative value by adding “1” to the upper bits by the multiplexer MUX2, even when the 32-bit data read from the bank BK during the sign-extending load has a negative value. During the sign-extending load, the multiplexers MUX1 and MUX 2 can select the data UDT or LDT divided from the read data RDT received by the data input port IP, and transfer the selected data to the data output port OP.

Moreover, the data distribution unit 10 includes that multiplexers MUX1 and MUX2 that are provided in correspondence with each load store unit LDST. Accordingly, during both the normal load and the sign-extending load, the data distribution unit 10 can read the correct 64-bit data and output the correct 64-bit data to the load store unit LDST that is the originator of the read access request.

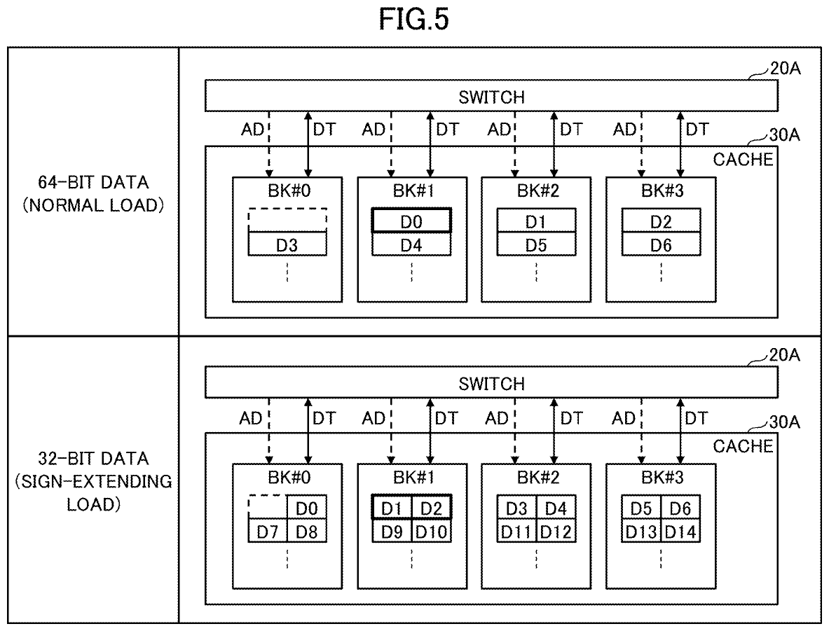

FIG. 5 illustrates an example of data disposed in the cache 30A illustrated in FIG. 3 or the cache 30 illustrated in FIG. 1. The example in which the data are disposed in the cache 30A will be described in the following, but the same applies to the example in which the data are disposed in the cache 30. Each load store unit LDST writes the data DT in units of 64 bits or 32 bits to each bank BK. During the normal load, each load store unit LDST reads the data DT from each bank BK in units of 64 bits (that is, in units of the sub data SDT). During the sign-extending load, each load store unit LDST reads the data DT from each bank BK in units of 32 bits (that is, in units of the divided data).

During the normal load, the 64-bit data D0 ready from the bank BK #1 is output, as the data DT, to the switch 20A, as indicated by bold markings inside a block of the bank BK #1 in an upper portion of FIG. 5. During the sign-extending load, the 32-bit data D1 and the 32-bit data D2 read from the bank BK #1 are output, as the data DT, to the switch 20A, as indicated by bold markings inside the block of the bank BK #1 in a lower portion of FIG. 5.

FIG. 6 illustrates an example of the operation of the data distribution unit 10A illustrated in FIG. 3 or the data distribution unit 10 illustrated in FIG. during the normal load. That is, FIG. 6 illustrates an example of the arithmetic processing method performed by the processor 100A or 100. The example of the operation of the data distribution unit 10A will be described in the following, but the same applies to the example of the operation of the data distribution unit 10.

in a section (A) illustrated in FIG. 6, the load store units LDST #0 through LDST #3 respectively issue the read access requests with respect to the banks BK #0 through BK #3. The banks BK #0 through BK #3 respectively output the held 64-bit data D0 through D3 to the switch 20A.

The switch 20A outputs upper bits U and lower bit L of the respective data D0 through D3 to the corresponding data input ports IP of the data distribution unit 10A. The upper bits U and the lower bits L respectively are 32 bits. The data distribution unit 10A outputs the upper bits U and the lower bits L of the data D0 through D3, as the 64-bit read data D0 through D3, to the respective load store units LDST #0 through LDST #3 that are the originators of the read access requests, via the respective data output ports OP.

In a section (B) illustrated in FIG. 6, the load store units LDST #0 through LDST #3 respectively issue the read access requests with respect to the banks BK #1 through BK #3 and BK #0. The banks BK #1 through BK#3 and BK #0 respectively output the held 64-bit data D0 through D3 to the switch 20A.

The switch 20A outputs the upper bits U and the lower bits L of the respective data D0 through D3 to the corresponding data input ports IP of the data distribution unit 10A. As illustrated in the section (B) of FIG. 6, the switch 20A outputs the data D0 through D3, respectively received from the banks BK #1 through BK #3 and BK 0, to the data input ports IP of the data distribution unit 10A corresponding to the load store units LDST #0 through LDST #3 that are the originators of the read access requests.

The data distribution unit 10A outputs the upper bits U and the lower bits L of the respective data D0 through D3, as the 64-bit read data D0 through D3, to the respective load store units LDST #0 through LDST #3 that are the originators of the read access requests, via the respective data output ports OP.

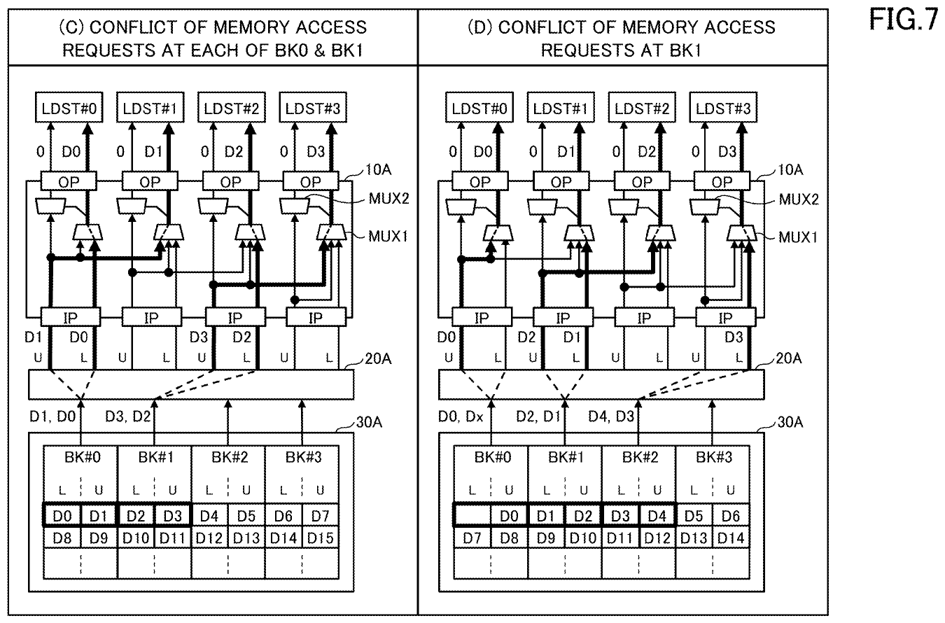

FIG. 7 illustrates an example of the operation of the data distribution unit 10A illustrated in FIG. 3 or the data distribution unit 10 illustrated in FIG. 1 during the sign-extending load. That is, FIG. 7 illustrates another example of an arithmetic processing method performed by the processor 100A or 100. The example, of the operation of the data distribution unit 10A be described in the following, but the same applies to the example of the operation of the data distribution unit 10. In FIG. 7, those operations that are the same as the operations described in conjunction with FIG. 6 will be omitted.

In a section (C) illustrated in FIG. 7, the load store units LDST #0 through LDST #3 issue the read access requests that respectively read four consecutive divided data D0 through D1 from the banks BK #0 and BK #1. In FIG. 7, a positional relationship of the upper bits U and the lower bits L of the data output from the switch 20A is opposite to the positional relationship of the upper bits U and the lower bits L of the data held by each bank BK.

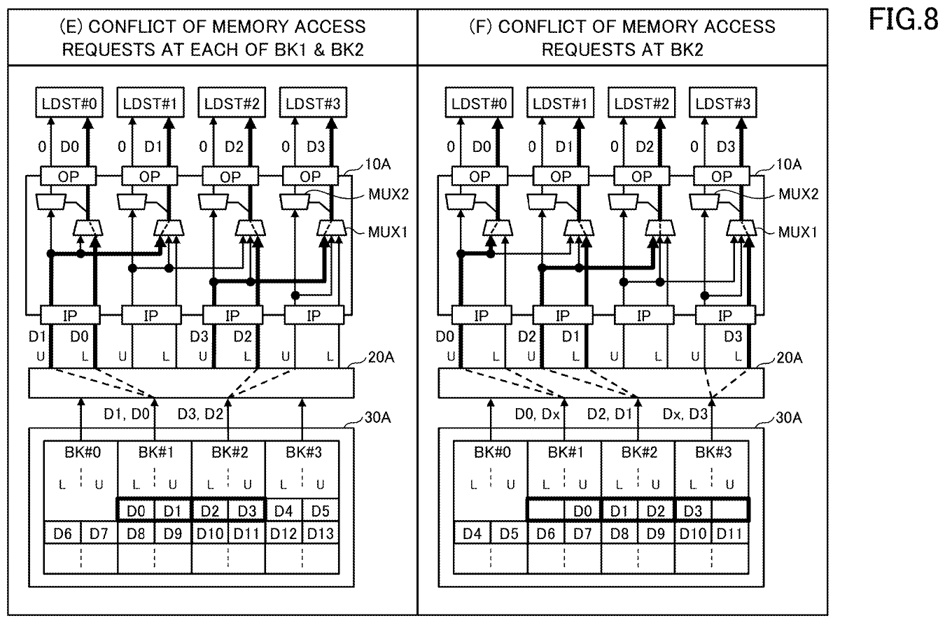

A conflict occurs between the read access requests issued from the load store units LDST #0 and LDST #1 with respect to the bank BK #0. A conflict occurs between the read access requests issued from the load store units LDST #2 and LDST #3 with respect to the bank BK #1. The conflict of the read access requests during the sign-extending load described in conjunction with FIG. 7 and FIG. 8 refers to a conflict that occurs when the two addresses of the read targets indicate the same sub data SDT, and does not refer to a conflict that occurs when the two addresses of the read targets indicate different sub data SDT.

When a conflict of the read access requests during the sign-extending load occurs, the switch 20A outputs one of the read access requests to the bank BK, and reads the sub data SDT including the two divided data, that are the read target, from the bank BK. The switch 20A outputs the read sub data SDT (including the two divided data) to the data distribution unit 10A.

The data distribution unit 10A selects the divided data D0 received as the lower bits L by the multiplexer MUX1 corresponding to the load store unit LDST #0, and outputs the selected divided data to the load store unit LDST #0 via the lower bit data line. In addition, the data distribution unit 10A selects the divided data D1 received as the upper bits U by the multiplexer MUX1 corresponding to the load store unit LDST #1, and outputs the selected divided data to the load store unit LDST #1 via the lower bit data line.

The data distribution unit 10A selects the divided data D2 received as the lower bits by the multiplexer MUX1 corresponding to the load store unit LDST #2, and outputs the selected divided data to the load store unit LDST #2 via the lower bit data line. In addition, the data distribution unit 10A selects the divided data D3 received as the upper bits U by the multiplexer MUX1 corresponding to the load store unit LDST #3, and outputs the selected divided data to the load store unit LDST #3 via the lower bit data line.

As described above, during the sign-extending load, the data distribution unit 10A can output the divided data received as the upper bits U or the lower bits to the load store unit LDST via the lower bit data line, by selecting the divided data by the multiplexer MUX1. In addition, when the data distribution unit 10A receives the sub data SDT including the two divided data, the data distribution unit 10A can respectively output the two divided data to two load store units LDST, by selecting the two divided data by mutually different multiplexers MUX1. In other words, the processor 100A can output the upper bits of the divided data and the lower bits of the divided data included in the sub data SDT read from the bank BK, as the lower bit data, to each of the two load store units LDST.

During the sign-extending load, the data distribution unit 10A outputs all-“0” data or all-“1” data from each multiplexer MUX2, according to whether the data output from each multiplexer MUX1 has the positive value or the negative value.

In a section (D) illustrated in FIG. 7, the load store units LDST #0 through LDST #3 issue the read access requests that respectively read four consecutive divided data D0 through D3 from the banks BK #0 through BK #2. The read access request issued from the load store unit LDST #0 with respect to the bank BK #0 causes no conflict. A conflict occurs between the read access requests issued from the load store units LDST #1 and LDST #2 with respect to the bank BK #1. The read access request issued from the load store unit LDST #3 with respect to the bank BK #2 causes no conflict.

The switch 20A outputs the read access requests to the banks BK #0 and BK #2, reads the sub data SDT including the divided data D0 from the bank BK #0, and reads the sub data SDT including the divided data D3 from the bank BK #2. The switch 20A outputs one of the read access requests to the bank BK #1 where a conflict of the read access requests occurs, and reads the sub data SDT including the two divided data D1 and D2 that are read targets from the bank BK #1.

The switch 20A outputs the sub data SDT including the divided data D0 read from the bank BK #0 to the data input port IP of the data distribution unit 10A corresponding to the load store unit LDST #0. The switch 20A outputs the sub data SDT including the divided data D1 and D2 read from the bank BK #1 to the data input port IP of the data distribution unit 10A corresponding to the load store unit LDST #1. The switch 20A outputs the sub data SDT including the divided data D3 read from the bank BK #2 to the data input port IP of the data distribution unit 10A corresponding to the load store unit LDST #3.

The data distribution unit 10A selects the divided data D0 received as the upper bits U by the multiplexer MUX1 corresponding to the load store unit LDST #0, and outputs the selected divided data D0 to the load store unit LDST #0. The data distribution unit 10A selects the divided data D2 received as the upper bits U by the multiplexer MUX1 corresponding to the load store unit LDST #2, and outputs the selected divided data D2 to the load store unit LDST #2.

The data distribution unit 10A selects the divided data D1 received as the lower bits L by the multiplexer MUX1 corresponding to the load store unit LDST #1, and outputs the selected divided data D1 to the load store unit LDST #1. The data distribution unit 10A selects the divided data D3 received as the lower bits L by the multiplexer MUX1 corresponding to the load store unit LDST #3, and outputs the selected divided data D3 to the load store unit LDST #3.

As illustrated in FIG. 7 and FIG. 8 that will be described later, the switch 20A outputs the sub data SDT read from each bank BK to one of the data input ports IP of the data distribution unit 10A in a state where the upper bits U and the lower bits L are combined. That is, during the sign-extending load, the operation of the switch 20A to transfer the read data to the data distribution unit 10A is the same as the operation during the normal load illustrated in FIG. 6. Accordingly, because a circuit specific to the operation during the sign-extending load does not need to be added to the switch 20A, it is possible to reduce an increase in the circuit scale of the switch 20A.

FIG. 8 illustrates another example of the operation of the data distribution unit 10A illustrated in FIG. 3 or the data distribution unit 10 illustrated in FIG. 1 during the sign-extending load. That is, FIG. 8 illustrates another example of the arithmetic processing method performed by the processor 100A or 100. The example of the operation of the data distribution unit 10A will be described in the following, but the same applies to the example of the operation of the data distribution unit 10. In FIG. 8, those operations that are the same as the operations described in conjunction with FIG. 6 and FIG. 7 will be omitted. In FIG. 8, the positional relationship of the upper bits U and the lower bits L of the data output from the switch 20A is opposite to the positional relationship of the upper bits U and the lower bits L of the data held by each bank BK, similar to FIG. 7.

In a section (E) illustrated in FIG. 8, the load store units LDST #0 through LDST #3 issue the read access requests that respectively read the four consecutive divided data D0 through D3 from the banks BK #1 and BK #2. A conflict occurs between the read access requests issued from the load store units LDST #0 and LDST #1 with respect to the bank BK #1. A conflict occurs between the read access requests issued from the load store units LDST #2 and LDST #3 with respect to the bank BK #2.

The switch 20A outputs one of the read access requests to each of the banks BK #1 and BK #2. The switch 20A outputs the sub data SDT including the two divided data D0 and D1 that are read from the bank BK #1 to the data distribution unit 10A, and outputs the sub data SDT including the two divided data D2 and D3 that are read from the bank BK #2 to the data distribution unit 10A. The operation of the data distribution unit 10A illustrated in the section (E) of FIG. 8 is the same as the operation illustrated in the section (C) of FIG. 7.

In a section (F) illustrated in FIG. 8, the load store units LDST #0 through LDST #3 issue the read access requests that respectively read the four consecutive divided data D0 through D3 from the banks BK #1 through BK #3. A conflict occurs between the read access requests issued from the load store unit LDST #1 and LDST #2 with respect to the bank BK #1.

The switch 20A outputs read access requests respectively to the banks BK #1 and BK #3 where a conflict of the read access requests does not occur, and outputs one of the read access requests to the bank BK #2 where the conflict of the read access requests occurs. The switch 20A reads the sub data SDT including the divided data D0 from the bank BK #1, reads the sub data SDT including the divided data D1 and D2 from the bank BK #2, and reads the sub data SDT including the divided data D3 from the bank BK #3. Further, the switch 20A outputs the read sub data SDT to the data distribution unit 10A. The operation of the data distribution unit 10A illustrated in the section (F) of FIG. 8 is the same as the operation illustrated in the section (D) of FIG. 7.

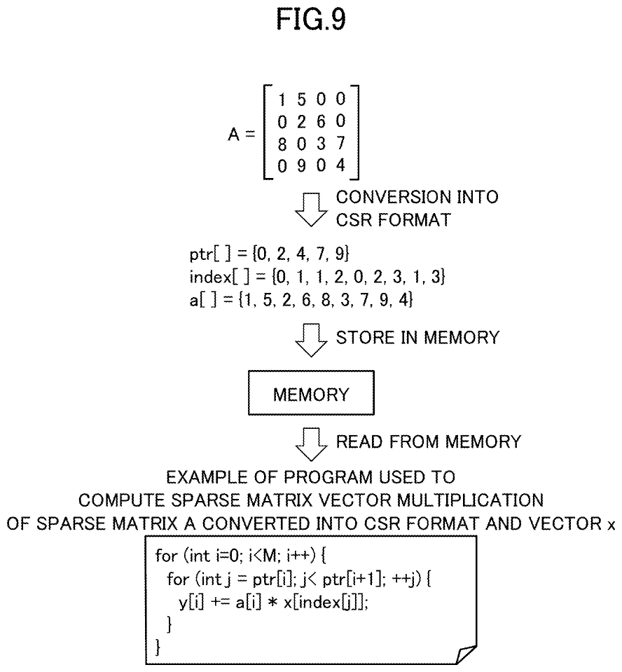

FIG. 9 illustrates an example of a sparse matrix vector multiplication. In order to simplify the description, the example, of FIG. 9 illustrates a sparse matrix A having four rows and four columns, that is, a 4×4 sparse matrix A. The example of the operation of the processor 100A illustrated in FIG. 3 will be described in the following, but the same applies to the example of the operation of the processor 100 illustrated in FIG. 1.

Computation of a sparse matrix vector multiplication is widely used in simulations or the like, and it is known that a computation time of the sparse matrix vector multiplication amounts to a large percentage of the simulation execution time. Because the sparse matrix A includes many zero elements, storage of the sparse matrix A into a memory is performed after being converted (compressed) into a Compressed Sparse Row (CSR) format, for example.

In the CSR format, elements of the sparse matrix A other than the zero elements are stored in an array a[ ]. An array ptr[ ] stores a position of a first element other than the zero element in each of the rows of the sparse matrix A, in the array a[ ]. An array index[ ] corresponds to each element of the array a[ ], and stores a column number of each element of the array a[ ] in the sparse matrix A.

For example, before the computation of the sparse matrix vector multiplication is performed by the processor 100A, the sparse matrix A converted into the CSR format is stored in the main memory 40 or the like. The processor 100A uses a program illustrated in FIG. 9, for example, when performing the computation of the sparse matrix vector multiplication of the sparse matrix A converted into the CSR format and a vector x. Hence, it is possible to compute the product of the sparse matrix A and the vector x, while reading the data of the CSR format from the main memory 40 via the cache 30A.

In FIG. 9, y[i], a[i], and x[ ] in the program are represented by a 64-bit floating point number, and index[ ] is represented by a 32-bit number, for example. The 32-bit index[ ] is stored in a memory area having consecutive addresses. In other words, index[ ] is stored as the sub data SDT in the area allocated with the same address in the plurality of banks BK, an illustrated in FIG. 7 and FIG. 8. When the computation of the sparse matrix vector multiplication is performed using the SIMD instruction, the processor 100A performs a sign-extending load when reading index[ ] from the cache 30A, and loads the 32-bit data into the register of the CPU core while extending the 32-bit data to 64-bit data.

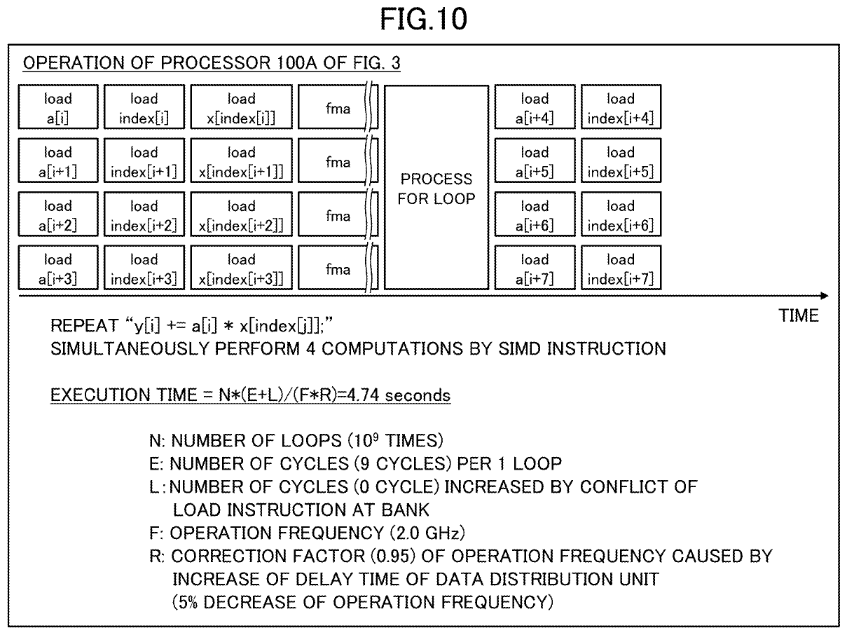

FIG. 10 illustrates an example of an operation when computing the sparse matrix vector multiplication. FIG. 10 illustrates an example of the operation of the processor 100A illustrated in FIG. 3, but the same applies to the example of the operation of the processor 100 illustrated in FIG. 1. In the example illustrated in FIG. 10, the data that is the computation target of the SIMD instruction consists of four parallel data.

The processor 100A repeatedly executes the first three load instructions, fused multiply-add (fma) instruction, and a process for loop. The loading of index[ ] from the memory uses a sign-extending load instruction. When the processor 100A having the data distribution unit 10A executes the sign-extending load instruction, it is possible to avoid a conflict of the read access requests when executing a load index[ ] instruction. For this reason, the processor 100A can simultaneously execute four load index[ ] instructions, and can simultaneously read four 32-bit data.

In a case where a number N of loops is 10⁹ times, a number of cycles per 1 loop is 9 cycles, an operating frequency F is 2.0 GHz, and a correction coefficient R is 0.95, an execution time of the computation of the sparse matrix vector multiplication is approximately 4.74 seconds. The correction coefficient R takes into consideration an increase in the delay time caused by the addition of the data distribution unit 10A. The value “0.95” of the correction coefficient R indicates a 5% decrease in the operating frequency due to the increase in the delay time. Because a conflict of the load instructions (sign-extending load) does not occur due to the provision of the data distribution unit 10A, a number L of cycles increased due to the conflict is zero cycles. The conflict of the load instructions refers to the conflict of two read access requests with respect to a single rank BK.

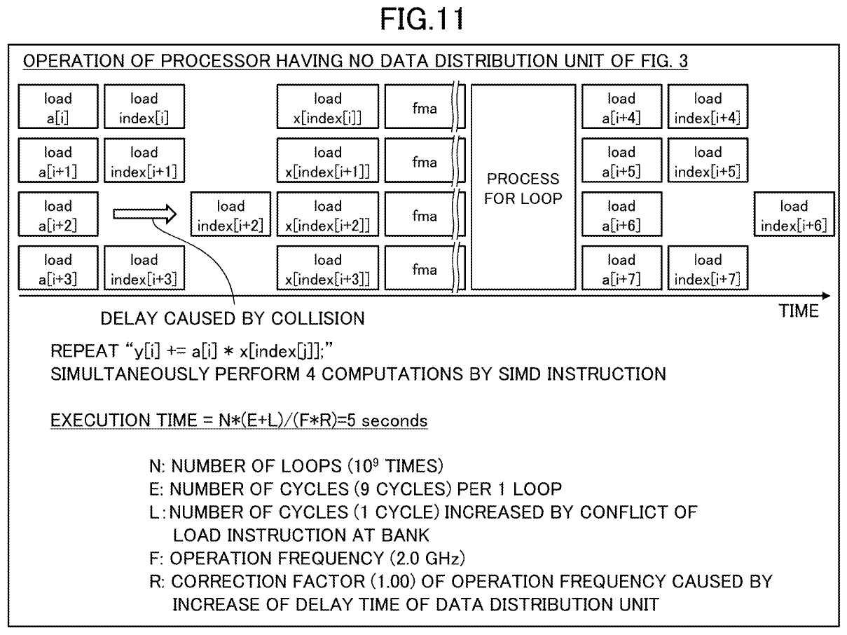

FIG. 11 illustrates another example of the operation when computing the sparse matrix vector multiplication. FIG. 11 illustrates an example of the operation of a processor that does not include the data distribution unit 10A illustrated in FIG. 3, but the same applies to an example of the operation of a processor that does not include the data distribution unit 10 illustrated in FIG. 1. In FIG. 11, those operations that are the same as the operations described in conjunction with FIG. 10 will be omitted.

When the processor does not include the data distribution unit 10A, a conflict occurs due to the 32-bit load index[ ] instructions of the sign-extending load. For this reason, the execution of the conflicting load index[ ] instructions is delayed by one cycle, thereby increasing the number of cycles required for each loop by one cycle. In addition, because the processor does not include the data distribution unit 10A, the correction coefficient R of the operating frequency is 1.00. As a result, the execution time of the computation of the sparse matrix vector multiplication becomes approximately 5 seconds. Accordingly, the processor 100A including the data distribution unit 10A can reduce the execution time of the computation of the sparse matrix vector multiplication by approximately 5% compared to the processor that does not include the data distribution unit 10A.

As described above, in this embodiment, it is possible to obtain effects that are the same as the effects obtainable in the first embodiment described above. For example, the processor 100A can reduce the delay of reading the plurality of divided data, even when the read target data of the plurality of read access requests respectively are the plurality of divided data included in the sub data SDT held in the banks BK.

Further, in this embodiment, during the sign-extending load, the data distribution unit 10A can output the upper bits of the divided data and the lower bits of the divided data included in the sub data SDT read from the bank BK to each of the two load store units LDST, as the lower bit data. In other words, the data distribution unit 10A can output the two divided data to the two load store units LDST, respectively, by selecting the two divided data by the mutually different multiplexers MUX1. As a result, the processor 100A can output the upper bits of the divided data and the lower bits of the divided data included in the sub data SDT read from the bank BK to each of the two load store units LDST, as the lower bit data.

Even when the, 32-bit data of the sign-extending load has a negative value, the data distribution unit 10A can generate 64-bit data having the negative value by adding “1”to the upper bits by the multiplexer MUX2, and output the 64-bit data to the load store unit LDST.

During the normal load, the data distribution unit 10A can output the lower bit data and the upper bit data received by the data input port IP, as the lower bit data and the upper bit data of the load store unit LDST, via the multiplexers MUX1 and MUX2. In other words, during the normal load, the data distribution unit 10A outputs the sub data SDT read from the bank BK, as is, to the load store unit LDST that is the originator of the read access request.

The four data output ports OP are provided in correspondence with the four data input ports IP. The number of the data input ports IP and the number of the data output ports OP of the data distribution unit 10A are the same as the number of the load store units LDST. For this reason, by transferring the sub data PDT read from the bank BK to one of the data input ports IP by the switch 20A, the sub data SDT or the divided data can be output to the load store unit LDST that is the originator of the read access request.

The data distribution unit 10A includes the multiplexers MUX1 and MUX2 that are provided in correspondence with the load store units LDST, respectively. Accordingly, during both the normal load and the sign-extending load, the data distribution unit 10A can output the correct 64-bit data to the load store unit LDST that is the originator of the read access request.

By controlling the operation of the data distribution unit 10A by the arbitration unit 50A, the plurality of divided data read from the bank BK can be output in parallel to each load store unit LDST, even when a conflict of the read access requests occur during the sign-extending load.

According to the embodiments described above, it is possible to reduce a delay of reading a plurality of second data, even when read target data of a plurality of read access requests respectively are the plurality of second data included in first data held in a bank.

The description above use terms such as “determine”, “identify”, or the like to describe the embodiments, however, such terms are abstractions of the actual operations that are performed. Hence, the actual operations that correspond to such terms may vary depending on the implementation, as is obvious to those skilled in the art.

Although the embodiments are numbered with, for example, “first”, and “second”, the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
a plurality of request issuing units respectively configured to issue a read access request with respect to a storage;
a cache including a plurality of banks respectively capable of holding first data divided from data read from the storage;
a switch configured to interconnect the plurality of request issuing units and the plurality of banks; and
a data distribution unit disposed between the plurality of request issuing units and the switch, wherein
the switch outputs one read access request of a plurality of read access requests to a bank that is a read target, when each of read target data of the plurality of read access requests issued from the plurality of request issuing units is one second data of a plurality of second data included in the first data,
the first data including the plurality of second data read from the bank is output to the data distribution unit, and
the data distribution unit outputs each second data of the plurality of second data, divided from the first data received from the switch, in parallel to a request issuing unit that is an originator of the read access request.

2. The processor as claimed in claim 1, wherein the data distribution unit outputs each second data of the plurality of second data to the request issuing unit that is the originator of the read access request via a lower bit data line, when each of the read target data of sign-extending type read access requests is the one second data of the plurality of second data included in the first data.

3. The processor as claimed in claim 2, wherein the data distribution unit outputs “1” to an upper bit data line, excluding the lower bit data line that outputs the second data having a negative value, when the plurality of second data have the negative value.

4. The processor as claimed in claim 2, wherein the data distribution unit outputs the first data read from one bank of the plurality of banks in correspondence with a non-sign-extending type read access request to the request issuing unit that is the originator of the read access request, without dividing the first data.

5. The processor as claimed in claim 1, wherein
the data distribution unit includes
a plurality of data input ports coupled to the switch,
a plurality of data output ports coupled to the plurality of request issuing units and corresponding to the plurality of data input ports, respectively, and
a selector configured to select one data output port of the plurality of data output ports to which each second data of the plurality of second data divided from the first data received by the data input port is to be transferred, and
the switch outputs the first data read from the bank to one data input port of the plurality of data input ports.

6. The processor as claimed in claim 5, wherein
the second data includes lower data and upper data that are divided from the first data by dividing the first data into two data portions, and
the selector includes
a lower bit selector configured to select the lower data or the upper data received by the data input port, and output the selected data from the data output port as lower bit data, and
a upper bit selector configured to select the upper data received by the data input port, all-“0” data, or all-“1” data, and output the selected data from the data output port as upper bit data.

7. The processor as claimed in claim 6, wherein the selector outputs the lower data and the upper data included in the first data received from the switch via the data input port, to a lower bit side of the data output port corresponding to the request issuing unit that is the originator of the read access request, when the read target data of sign-extending type read access requests are the plurality of second data included in the first data.

8. The processor as claimed in claim 1, further comprising:
an arbitration unit configured to arbitrate the plurality of read access requests issued from the plurality of request issuing units, and control operations of the switch and the data distribution unit according to an arbitration result.

9. An arithmetic processing method to be implemented in a processor that includes a plurality of request issuing units respectively configured to issue a read access request with respect to a storage, a cache including a plurality of banks respectively capable of holding first data divided from data read from the storage, a switch configured to interconnect the plurality of request issuing units and the plurality of banks, and a data distribution unit disposed between the plurality of request issuing units and the switch, the arithmetic processing method comprising;
outputting, by the switch, one read access request of a plurality of read access requests to a bank that is a read target, when each of read target data of the plurality of read access requests issued from the plurality of request issuing units is one second data of a plurality of second data included in the first data;
outputting, by the switch, the first data including the plurality of second data read from the bank to the data distribution unit; and
outputting, by the data distribution unit, each second data of the plurality of second data, divided from the first data received from the switch, in parallel to a request issuing unit that is an originator of the read access request.

10. The arithmetic processing method as claimed in claim 9, wherein the outputting, by the data distribution unit, outputs each second data of the plurality of second data to the request issuing unit that is the originator of the read access request via a lower bit data line, when each of the read target data of sign-extending type read access requests is the one second data of the plurality of second data included in the first data.

11. The arithmetic processing method as claimed in claim 10, wherein the outputting, by the data distribution unit, outputs “1” to an upper bit data line, excluding the lower bit data line that outputs the second data having a negative value, when the plurality of second data have the negative value.

12. The arithmetic processing method as claimed in claim 10, wherein the outputting, by the data distribution unit, outputs the first data read from one bank of the plurality of banks in correspondence with a non-sign-extending type read access request to the request issuing unit that is the originator of the read access request, without dividing the first data.
